(19) United States
(12) Patent Application Publication
(10) Pub. No.: US 2026/0120437 A1
(43) Pub. Date: Apr. 30, 2026

(54) SYSTEM AND METHOD FOR GENERATING A DATA PIPELINE FOR COMPUTER VISION

(71) Applicant: L&T TECHNOLOGY SERVICES LIMITED, Chennai (IN)

(72) Inventors: SIVAM MURUGESAN GAJENDRAN, Chennai (IN); NIRMALA DEVI MAL NADAR, Kanchipuram (IN); UNMAI RASHEEDKHAN REGINA, Chennai (IN); ABIRAMI GUGANATHAN, Tiruchirapalli (IN)

(21) Appl. No.: 19/060,802

(22) Filed: Feb. 24, 2025

(30) Foreign Application Priority Data
Oct. 25, 2024 (IN) 202441081981

(51) Int. Cl. G06V 10/774; G06V 10/56; G06V 10/72; G06V 10/764; G06V 10/776; G06V 20/70

(52) U.S. Cl. CPC G06V 10/774; G06V 10/56; G06V 10/72; G06V 10/764; G06V 10/776; G06V 20/70

(57) ABSTRACT

Embodiments disclosed herein provide a method and system for generating a data pipeline for computer vision. The system configured to receive a user dataset, the user dataset comprises a plurality of images, and the plurality of images comprises at least one of an intensity value and a plurality of colour channels associated with each of a plurality of pixels of the plurality of images. The system is further configured to analyse and pre-process the user dataset, to perform a frequency domain processing and a spatial domain processing of the plurality of images based on a first gradient level and a second gradient level to compute the data pipeline based on the frequency domain processing and the spatial domain processing.

### CROSS-REFERENCE TO RELATED APPLICATIONS

This application is a Non-Provisional Application, which claims priority to the Indian non-provisional patent application No. 202441081981, filed Oct. 25, 2024, entitled “SYSTEM AND METHOD FOR GENERATING A DATA PIPELINE FOR COMPUTER VISION”, which is hereby incorporated by reference in its entirety.

### DESCRIPTION

The following specification particularly describes the invention and the manner in which it is to be performed.

### TECHNICAL FIELD

The present disclosure generally relates to the field of computer vision, and more particularly relates to a method and system for generating a format agnostic data pipeline for improving the quality of datasets used in finetuning a computer vision model in the computer vision to classify and detect objects.

### BACKGROUND OF THE DISCLOSURE

The information disclosed in this background section is only for enhancement of understanding of the general background of the disclosure and should not be taken as an acknowledgement or any form of suggestion that this information forms the prior art already known to a person skilled in the art.

In general, computer vision is a technique used in applications, without limiting, to health care, autonomous vehicles, agriculture, facial recognition, etc. However, the accuracy of the computer vision to recognize a subject or an object is limited to the quality of the images in a dataset received by the computer vision model. Conventionally, the dataset generation is time consuming and effort demanding task. Further, cloud-based dataset generators may compromise privacy and security of the data. Without any limitation, the confidential data may comprise data related to defense, clinical biology, industrial plants etc.

The image data need to be converted into a dataset based on an edge device model architecture and framework. However, each framework requires their own dataset formats for training and fine tuning. Therefore, the conventional dataset generation techniques for the computer vision are time consuming and/or inefficient.

Accordingly, there is a need for a technique that overcomes the limitations stated above in relation to the existing technology.

### SUMMARY OF THE DISCLOSURE

In an embodiment, the present disclosure relates to a method of generating a data pipeline for computer vision models, comprising receiving a dataset, the dataset comprises a plurality of images, and the plurality of images comprises at least one of an intensity value and a plurality of colour channels associated with each of a plurality of pixels of the plurality of images. The method further comprises analysing and pre-processing the dataset, the pre-processing comprises determining a first gradient level associated with the intensity value of each of the plurality of pixels and determining a second gradient level associated with each of the plurality of colour channels associated with each of the plurality of pixels. The method further comprises performing a frequency domain processing and a spatial domain processing of the plurality of images based on the first gradient level and the second gradient level. Lastly, the method comprises computing the data pipeline based on the frequency domain processing and the spatial domain processing.

In another embodiment, the present disclosure relates to a system for generating a data pipeline for computer vision models, comprising a memory and a processor. The processor communicatively coupled with the memory, the processor configured to receive a dataset, the dataset comprises a plurality of images, wherein the plurality of images comprises at least one of an intensity value and a plurality of colour channels associated with each of a plurality of pixels of the plurality of images. The processor further configured to analyse and pre-process the dataset, wherein the pre-processing comprises determining a first gradient level associated with the intensity value of each of the plurality of pixels and determining a second gradient level associated with each of the plurality of colour channels associated with each of the plurality of pixels. The processor further configured to perform a frequency domain processing and a spatial domain processing of the plurality of images based on the first gradient level and the second gradient level. Lastly, the processor further configured to compute the data pipeline is based on the frequency domain processing and the spatial domain processing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Features, aspects, and advantages of embodiments of the disclosure will be described below with reference to the accompanying drawings, in which reference numerals denote like elements, and wherein:

FIG. 1 illustrates an environment diagram for generating data pipeline for computer vision, in accordance with some embodiments of the present disclosure.

FIG. 2 illustrates a block diagram for generating data pipeline for computer vision, in accordance with some embodiments of the present disclosure.

FIG. 3 illustrates a process flow for generating data pipeline with image processing data pipeline for computer vision, in accordance with some embodiments of the present disclosure.

FIG. 4 illustrates a flow chart of a method for generating data pipeline with image processing for computer vision, in accordance with some embodiments of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF THE DISCLOSURE

The following detailed description of example embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods described herein may be implemented in different forms of hardware, software, or a combination of hardware and software. The actual specialized control hardware or software code used to implement these systems and/or methods is not limiting the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

In general, to improve the accuracy of the computer vision to recognize a subject or an object is limited to the quality of the images in a dataset received by the computer vision model. Further, the dataset generation is a time consuming and effort demanding task. The image data may need to be converted into a dataset based on an edge device model architecture and framework. However, each framework requires their own dataset formats for training and fine tuning. Therefore, the conventional dataset generation techniques for the computer vision models are time consuming and/or inefficient.

The methods and systems of the present disclosure solve a technical problem relating to the generation of a format agnostic dataset for fine tuning a model that can be deployed for an edge device operation, which is compatible with any known computer vision model or a framework. The present disclosure solves this technical problem as described in the embodiments below.

Embodiments disclosed herein provide a method and system for generating a data pipeline for computer vision. The present disclosure may receive a dataset of any known data format to enhance the dataset. Further, the enhanced dataset may be converted into the compatible format for the model or framework, efficiently and in less time.

Thus, the present disclosure enables an efficient technique for the dataset generation for computer vision of the edge device in a dataset format agnostic manner.

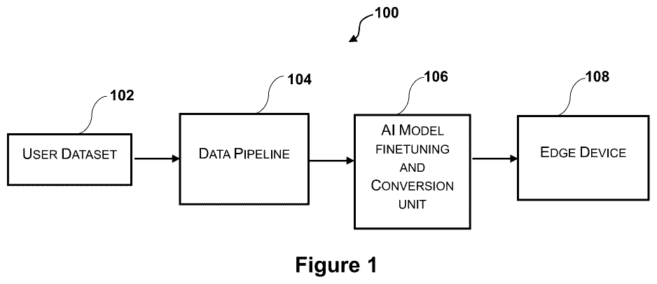

FIG. 1 illustrates an environment diagram of generating a data pipeline for computer vision, in accordance with some embodiments of the present disclosure.

As shown in FIG. 1, the environment 100 diagram of a data pipeline for computer vision is disclosed. The environment 100 comprises a user dataset 102, a data pipeline 104 for computer vision, an AI model finetuning and conversion unit 106 and an edge device 108.

In a non-limiting embodiment, the data pipeline 104 with image processing may receive the user dataset 102. In a non-limiting example, the user dataset 102 may comprise at least one of raw images, such as, without limiting to, Joint Photographic Expert Group (JPEG or JPG), Red Green Blue (RGB) images, Portable Network Graphics (PNG), etc. or a dataset. The user dataset may be in any known format, such as, but not limited to, tensorflow dataset (TFDS), NumPy Python package (NPZ) dataset, torch vision, etc.

The data pipeline 104 may, upon receiving the user dataset 102, process the user dataset compatible with the chosen AI model to get deployed in an edge device 108. In a non-limiting example, the edge device 108 may be at least one of a camera or a network of cameras to recognize a few objects or human individuals, a drone etc.

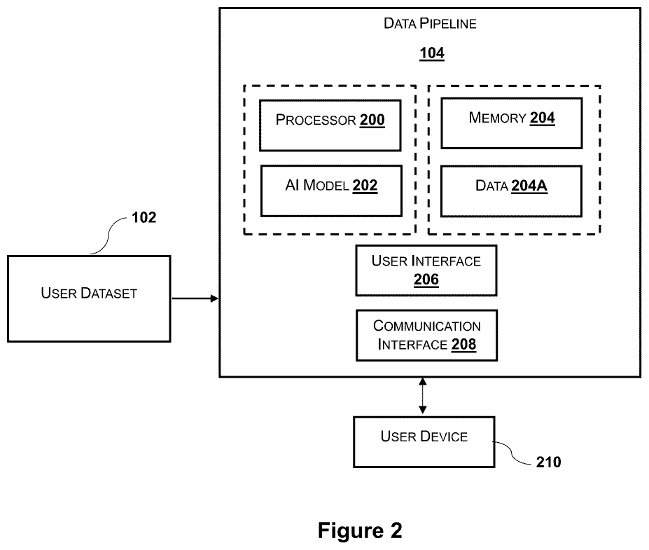

In a non-limiting embodiment, the data pipeline 104, as discussed earlier, may receive raw images or the dataset of any format and process the received dataset into the dataset compatible with the computer vision model or framework. In yet another non-limiting embodiment, the data pipeline 104 may be communicatively coupled to the AI Model finetuning and conversion unit 106 or the data pipeline 104 may also recite the AI model finetuning and conversion unit 106 within the data pipeline 104 to perform the one or more desired functions of the present disclosure. In a non-limiting example, the receive user dataset may comprise a raw image or a dataset format, such as TFDS or NPZ, whereas the edge device may require the dataset in TFDS format. The data pipeline 104 may receive the user dataset and may determine if the received user dataset needs to be converted based on the edge device format, such as TFDS or NPZ, etc. A detailed explanation of the data pipeline 104 for computer vision is provided in the forthcoming paragraphs in conjunction with FIGS. 2-4.

FIG. 2 illustrates a block diagram for generating a data pipeline for computer vision, in accordance with some embodiments of the present disclosure.

FIG. 2 illustrates an exemplary block diagram for generating a data pipeline 104 with image processing. In a non-limiting embodiment of the present disclosure, as discussed earlier, the data pipeline 104 may receive the user dataset 102. The data pipeline generator 104 may comprise a processor 20, an artificial intelligence (AI) model 202, a memory 204, a data 204A, a user interface 206, a communication interface 208, and a user device 210, which are communicatively coupled with each other to perform the desired functions of the present disclosure. For example, the processor 200 may be configured to perform the analyses and pre-processing of the dataset to finetune the AI model 202 that will be deployed in the edge device.

In a non-limiting embodiment of the present disclosure, the data pipeline 104 may be a data pipeline generator microservice to receive the user dataset 102 to perform the analyses and pre-process the dataset to be compatible with the AI model 202 framework that can be deployed in edge device, as discussed in earlier embodiments.

In the illustrated figure, the pipeline 104 is shown to recite the processor 200 and may be implemented as one or more microprocessors, microcomputers, microcontrollers, digital signal processors, central processing units, state machines, logic circuitries, Graphical processing units and/or any devices that manipulate signals based on operational instructions. However, one of the ordinary skill will appreciate that in other embodiments, the pipeline 104 may also form a part of the processor 200 and may be implemented through software or hardware or a suitable combination of software and hardware as per the embodiment requirements of the present disclosure. In said embodiment, the processor 200 may perform all the functions carried out by the pipeline 104. In one non-limiting example, the pipeline 104 may include an AI learning engine which may be employed to implement an AI model that is suitable to receive the dataset of any known format as discussed earlier and may enhance and convert it into the data format compatible with the model and framework that can be deployed in an edge device.

In one non-limiting embodiment of the present disclosure, upon receiving the user dataset 102 wherein the user dataset comprises a plurality of images. The plurality of images may be a raw image or a dataset of TFDS, NPZ data format, as discussed in earlier embodiments. The plurality of images may comprise at least one of an intensity value and a plurality of colour channels associated with each of a plurality of pixels of the plurality of images. The processor 200 may be further configured to analyse and pre-process the dataset to finetune and enhance the dataset. The pre-processing may comprise determining a first gradient level associated with the intensity value of each of the plurality of pixels. The pre-processing may further include determining a second gradient level associated with each of the plurality of colour channels associated with each of the plurality of pixels. The processor 200 may further perform a frequency domain processing and a spatial domain processing of the plurality of images based on the first gradient level and the second gradient level. The processor 200 may further compute the data pipeline based on the frequency domain processing and the spatial domain processing.

In yet another non-limiting embodiment, the processor 200 may further employ a learning agent to identify a format of the received user dataset to determine the dataset format compatible with a model framework, wherein the model can be finetuned and deployed in an edge device. The learning agent may further determine if the received dataset is compatible with the framework by comparing the format of the received dataset and the dataset format compatible with the framework and convert, based on the determination that the received dataset is non-compatible with the framework, the format of the received dataset into the dataset format compatible with the framework.

In yet another embodiment, the processor 200 may perform preprocessing of the received plurality of images further comprises determining a mean gradient level associated with the intensity value of each of the plurality of colour channels of pixels. For example, the mean gradient level may be computed based on the first gradient level and the second gradient level. The preprocessing may further comprise performing the frequency domain processing based on the determined mean gradient level of the plurality for the coloured images. The frequency domain processing may comprise analysing the received plurality of images with respect to determined mean gradient level, determine the convolution kernel in frequency domain and compute the new pixel value. The preprocessing may further comprise performing, upon performing the frequency domain processing, the spatial domain processing for the coloured images. For example, the spatial domain processing may comprise enhancing the received plurality images by manipulating individual pixels based on their spatial coordinates at a specific resolution. The frequency domain processing and the spatial domain processing may comprise determining kernel size and a value of standard deviation associated with a low pass filter. In an example, the low pass filter is employed to perform the spatial domain processing, generating a pre-processed image from the plurality of images of the received user dataset, based on the determined kernel size and the value of standard deviation. The frequency domain processing and the spatial domain processing may comprise implementing the spatial domain processing to highlight a plurality of features of the pre-processed image. Further, upon implementing the spatial domain processing, the frequency domain processing may be implemented by employing a high pass filter over the pre-processed image.

In yet another non-limiting embodiment, the processor 200 may compute the data pipeline from the received plurality of images in the compatible format and deployed in a local environment.

In one non-limiting embodiment of the present disclosure, the processor 200 may be implemented as one or more microprocessors, microcomputers, microcontrollers, digital signal processors, central processing units, state machines, logic circuitries, graphical processing units and/or any devices that manipulate signals based on operational instructions. Among other capabilities, the at least one processor 200 may be configured to fetch and execute computer-readable instructions stored in the memory 204.

In one non-limiting embodiment of the present disclosure, the memory 204 may include any computer-readable medium or computer program product known in the art including, for example, volatile memory, such as, static random-access memory (SRAM) and dynamic random-access memory (DRAM), and/or non-volatile memory, such as read only memory (ROM), erasable programmable ROM, flash memories, hard disks, optical disks, and magnetic tapes. Data/information may be stored within the memory 204 in the form of various data structures. The memory 204 may also store other data such as temporary data and temporary files, generated by the processor 200 or the pipeline 104 for performing the various functions of the present disclosure. In yet another non-limiting embodiment of the present disclosure, the memory 204 may comprise the data 204A. The data 204A may include, without limiting to, a meta data, any additional or supplemental data to perform the desired functions of the present disclosure. In yet another non-limiting embodiment of the present disclosure, the AI model 202 may be implemented using/or software, and partly by software or firmware. In one embodiment, the AI model 202 may be configured within the processor 200. The AI model 202 may be communicatively coupled to the processor 200, the memory 204, the user interface 206, and the communication interface 208 for implementing various embodiments as per the present subject matter.

In one non-limiting embodiment of the present disclosure, the processor 200 may receive a user input via the user interface 206. In a non-limiting example, test engineer may interact with the pipeline 104 via the user interface 206 to input the edge device compatible AI model framework details. The processor 200 may communicate with the user device 210 via the communication interface 206. In a non-limiting example, the communication interface 206 may refer to a hardware or a software suitable for transmitting and receiving data between the pipeline 104 and the user device 210.

According to one exemplary embodiment, the pipeline 104 may be communicatively coupled with the test engineer's computing device. In a non-limiting example, the test engineer's computing device may be a mobile or portable computing device, a desktop computer, a server, and/or the like.

According to one exemplary embodiment, the pipeline 104 may receive the user dataset 102 in any data format and may analyse and pre-process the user dataset to enhance and finetune the user dataset 102 to be compatible with the AI model framework.

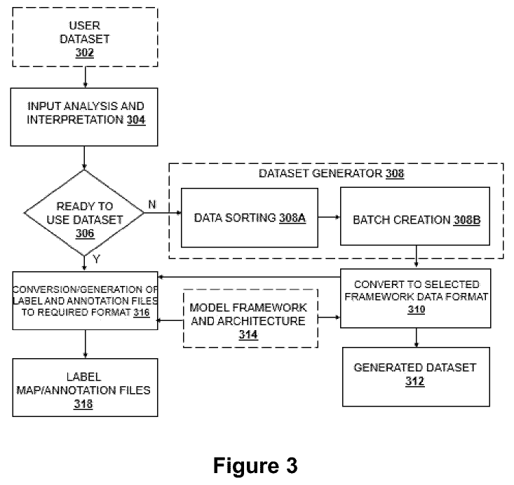

FIG. 3 illustrates a process flow for generating a data pipeline with image processing, in accordance with some embodiments of the present disclosure.

FIG. 3 represents a process flow of an exemplary method of generating a data pipeline with image processing, in accordance with one or more embodiments of the present disclosure. The order in which the process 300 is described is not intended to be construed as a limitation, and any number of the described process blocks may be combined in any order to implement the process. Additionally, individual blocks may be deleted from methods without departing from the spirit and scope of the subject matter described. Furthermore, the process can be implemented in any suitable hardware, software, firmware, or combination thereof. However, for ease of explanation, in the embodiments described below, the process 300 may be considered to be implemented by the AI-based data pipeline 104 with image processing and/or by the processor 204 of the data pipeline 104 of FIG. 2.

At step 302, the process 300 may include receiving user dataset. In a non-limiting example, the user dataset may be received via a uniform resource locator (URL) or a local folder, as discussed in earlier embodiments of FIGS. 1-2.

At step 304, the process 300 may include analyzing and interpretation of the received user dataset. In a non-limiting example, the analyzing and interpretation may include analyzing if the received images are compressed or uncompressed and pre-process the user dataset to enhance the user dataset, as discussed in earlier embodiments of FIGS. 1-2.

At step 306 the process 300 may determine if the received user dataset is ready to use. In a non-limiting example if the received user dataset and the edge device compatible user dataset are same, then the user dataset is determined as ready to use, as discussed in earlier embodiments of FIGS. 1-2.

At step 308 the process 300 may upon determining that the user dataset is not ready to use, may send it to the dataset generator to perform data sorting 308A and batch creation 308B. In a non-limiting example, the data sorting may include creating folders of class names. Without any limitation the classes may include human, animal, trees etc., to finetune the model. Further the batch creation may include creating a training dataset, validation dataset, and a test dataset for finetuning the model, as discussed in earlier embodiments of FIGS. 1-2.

At step 310 the process 300 may include converting the received user dataset into the selected framework data format. In a non-limiting example, the selected framework data format may be the edge device framework format such as model framework and architecture 314, as discussed in earlier embodiments of FIGS. 1-2.

At step 312 the process 300 may include generating the dataset based on the step 310, as discussed in earlier embodiments of FIGS. 1-2.

At step 316 the process 300 may include conversion or generation of label and annotation files to the required format, as discussed in earlier embodiments of FIGS. 1-2.

At step 318 the process 400 may include label and map or annotation files, as discussed in earlier embodiments of FIGS. 1-2.

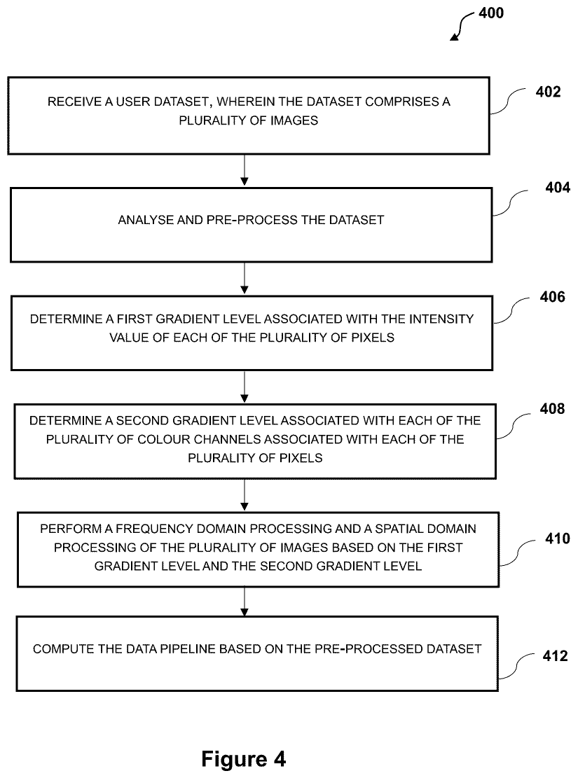

FIG. 4 illustrates a method for generating a data pipeline with image processing in accordance with some embodiments of the present disclosure.

The order in which the exemplary method 400 is described is not intended to be construed as a limitation, and any number of the described method blocks may be combined in any order to implement the method. Additionally, individual blocks may be deleted from the methods without departing from the spirit and scope of the subject matter described. Furthermore, the method can be implemented in any suitable hardware, software, firmware, or combination thereof. However, for case of explanation, in the embodiments described below, the method 400 may be considered to be implemented by the AI-based data pipeline 104 with image processing and/or by the processor 204 of the data pipeline 104 of FIG. 2.

At step 402, the method 400 may include receiving a user dataset, wherein the user dataset comprises a plurality of images, wherein the plurality of images comprises at least one of an intensity value and a plurality of colour channels associated with each of a plurality of pixels of the plurality of images, as discussed in earlier embodiments.

At step 404, the method 400 may include performing finite element analysis (FEA) to simulate mode shapes, as discussed in earlier embodiments.

At step 406, the method 400 may include analysing and pre-processing the dataset, as discussed in earlier embodiments.

At step 408, the method 400 may include determining a first gradient level associated with the intensity value of each of the plurality of pixels, as discussed in earlier embodiments.

At step 410, the method 400 may include determining a second gradient level associated with each of the plurality of colour channels associated with each of the plurality of pixels, as discussed in earlier embodiments.

At step 412, the method 400 may include performing a frequency domain processing and a spatial domain processing of the plurality of images based on the first gradient level and the second gradient level, as discussed in earlier embodiments.

At step 414, the method 400 may include computing the data pipeline based on the frequency domain processing and the spatial domain processing.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

Alternatives will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory, read-only memory, volatile memory, non-volatile memory, hard drives, CD ROMs, DVDs, flash drives, disks, and any other known physical storage media.

Suitable processors include, by way of example, a general-purpose processor, a special purpose processor, a conventional processor, a digital signal processor, a graphic processing unit, a plurality of microprocessors, one or more microprocessors in association with a DSP core, a controller, a microcontroller, Application Specific Integrated Circuits, Field Programmable Gate Arrays circuits, any other type of integrated circuit, and/or a state machine.

Advantages of the embodiment of the present disclosure are illustrated herein—As previously indicated, the present disclosure facilitates an efficient and data format agnostic dataset generation with image processing.

### REFERENCE NUMERALS

| Description | Reference number |
|---|---|
| 100 | Exemplary Environment |
| 102 | Dataset |
| 104 | Data Pipeline with Image Processing |
| 106 | Edge Device |
| 20 | Processor |
| 202 | AI Model |
| 204 | Memory |
| 204A | Data |
| 206 | User Interface |
| 208 | Communication Interface |
| 210 | User Device |
| 300 | Process |
| 302-318 | Process Flow |
| 400 | Method |
| 402-412 | Method Steps |

What is claimed is:

1. A method of generating a data pipeline for computer vision, comprising:
receiving a dataset, wherein the dataset comprises a plurality of images, wherein the plurality of images comprises at least one of an intensity value and a plurality of colour channels associated with each of a plurality of pixels of the plurality of images;
analysing and pre-processing the dataset, wherein the pre-processing comprises:
determining a first gradient level associated with the intensity value of each of the plurality of pixels;
determining a second gradient level associated with each of the plurality of colour channels associated with each of the plurality of pixels;
performing a frequency domain processing and a spatial domain processing of the plurality of images based on the first gradient level and the second gradient level; and
computing the data pipeline for the computer vision based on the frequency domain processing and the spatial domain processing.

2. The method of claim 1, wherein the analysing of the dataset comprises:
employing a learning agent to:
identify a format of the received dataset;
determine the dataset format compatible with an edge device framework;
determine if the received dataset is compatible with the framework by comparing the format of the received dataset and the dataset format compatible with the framework; and
converting, based on the determination that the received dataset is non-compatible with the framework, the format of the received dataset into the dataset format compatible with the framework.

3. The method of claim 1, wherein performing the pre-processing of the dataset comprises:
categorizing, upon the determining of the second gradient level, the plurality of images based on associated classes using a deep learning model, wherein the categorizing comprising:
assigning a first sub-set of the received dataset as a training dataset;
assigning a second sub-set of the received dataset as a validation dataset for cross validating an output of the deep learning model; and
generating, based on the first sub-set and the second sub-set of the received dataset, annotations and label map of the plurality of images compatible with the deep learning model framework format, wherein generating the annotations and the label map of the plurality of images comprises:
generating the annotation based on a pre-trained object detection model;
generating the label map based on a model inference while executing the model, from associated classes of the plurality of images; and
converting the label map and the annotation to compatible format;
creating, based on the generated annotations and the label map, batches on the subsets of received dataset as training batches and validation batches from the pre-processed dataset;
optimizing the deep learning model based on the training dataset and the validation dataset from the pre-processed dataset; storing the received plurality of images based on the associated classes in different locations; and
converting the format of the plurality of images in each folder into a format compatible with the deep learning model framework.

4. The method of claim 1, wherein the preprocessing of the received plurality of images further comprises:
determining a mean gradient level associated with the intensity value of each of the plurality of colour channels of pixels, wherein the mean gradient level is computed based on the first gradient level and the second gradient level;
performing the frequency domain processing based on the determined mean gradient level of the plurality for the coloured images, wherein the frequency domain processing comprises analysing the received plurality of images with respect to frequency and time; and
performing, upon performing the frequency domain processing, the spatial domain processing for the coloured images, wherein the spatial domain processing comprising enhancing the received plurality images by manipulating individual pixels based on their spatial coordinates at a specific resolution;
wherein the performing of the frequency domain processing and the spatial domain processing comprises:
determining kernel size and a value of standard deviation associated with a low pass filter, wherein the low pass filter is employed to perform the spatial domain processing;
generating a pre-processed image from the plurality of images of the received dataset, based on the determined kernel size and the value of standard deviation;
implementing the spatial domain processing to highlight a plurality of features of the pre-processed image; and
implementing, upon implementing the spatial domain processing, the frequency domain processing by employing a high pass filter over the pre-processed image.

5. The method of claim 1, wherein the data pipeline is computed from either the received plurality of images in the compatible format and deployed in a local environment.

6. A system for generating a data pipeline for computer vision, comprising:
a memory; and
a processor communicatively coupled with the memory, the processor configured to: receive a dataset, wherein the dataset comprises a plurality of images, wherein the plurality of images comprises at least one of an intensity value and a plurality of colour channels associated with each of a plurality of pixels of the plurality of images;
analyse and pre-process the dataset, wherein the pre-processing comprises:
determine a first gradient level associated with the intensity value of each of the plurality of pixels;
determine a second gradient level associated with each of the plurality of colour channels associated with each of the plurality of pixels; and
perform a frequency domain processing and a spatial domain processing of the plurality of images based on the first gradient level and the second gradient level; and
compute the data pipeline for the computer vision based on the frequency domain processing and the spatial domain processing.

7. The system of claim 6, wherein, to analyse the dataset, the processor is further configured to: employ a learning agent to:
identify a format of the received dataset;
determine the dataset format compatible with an edge device framework;
determine if the received dataset is compatible with the framework by comparing the format of the received dataset and the dataset format compatible with the framework; and
convert, based on the determination that the received dataset is non-compatible with the framework, the format of the received dataset into the dataset format compatible with the framework.

8. The system of claim 6, wherein, to pre-process the dataset, the processor is further configured to:
categorize, upon the determining of the second gradient level, the plurality of images based on associated classes using a deep learning model, wherein to categorize the processor further configured to:
assign a first sub-set of the received dataset as a training dataset;
assign a second sub-set of the received dataset as a validation dataset for cross validating an output of the deep learning model; and
generate, based on the first sub-set and the second sub-set of the received dataset, annotations and label map of the received raw images compatible with the deep learning model framework format; wherein to generate the annotations and the label map of the received raw images, the processor further configured to:
generate the annotation based on a pre-trained object detection model;
generate the label map based on a model inference while executing the model, from associated classes of the plurality of images; and
convert generated label map and annotation to compatible format;
creating, based on the generated annotations and the label map, batches on the subsets of received dataset as training batches and validation batches from the pre-processed dataset;
optimize the deep learning model based on the training and the validation batches from the pre-processed dataset;
store the received plurality of images based on the associated classes in different locations; and
convert the format of the received plurality of images in each folder into a format compatible with the deep learning model framework.

9. The system of claim 6, wherein, to perform preprocessing of the received plurality of images, the processor further configured to:
determine a mean gradient level associated with the intensity value of each of the plurality of colour channels of pixels, wherein the mean gradient level is computed based on the first gradient level and the second gradient level;
perform the frequency domain processing based on the determined mean gradient level of the plurality for the coloured images, wherein the frequency domain processing comprises analysing the received plurality images with respect to frequency and time; and
perform, upon performing the frequency domain processing, the spatial domain processing for the coloured images, wherein the spatial domain processing comprises enhancing the received plurality of images by manipulating individual pixels based on their spatial coordinates at a specific resolution;
wherein to perform the frequency domain processing and the spatial domain processing, the processor further configured to:
determine kernel size and a value of standard deviation associated with a low pass filter, wherein the low pass filter is employed to perform the spatial domain processing;
generate a pre-processed image from the plurality of images of the received dataset, based on the determined kernel size and the value of standard deviation;
implement the spatial domain processing to highlight a plurality of features of the pre-processed image; and
implement, upon implementing the spatial domain processing, the frequency domain processing by employing a high pass filter over the pre-processed image.

10. The system of claim 6, wherein the data pipeline is computed from either the received plurality of images in the compatible format and deployed in a local environment.

11. A non-transitory computer-readable medium storing computer-executable instruction for generating a data pipeline for computer vision, the computer-executable instructions configured for:
receiving a dataset, wherein the dataset comprises a plurality of images, wherein the plurality of images comprises at least one of an intensity value and a plurality of colour channels associated with each of a plurality of pixels of the plurality of images;
analysing and pre-processing the dataset, wherein the pre-processing comprises:
determining a first gradient level associated with the intensity value of each of the plurality of pixels;
determining a second gradient level associated with each of the plurality of colour channels associated with each of the plurality of pixels;
performing a frequency domain processing and a spatial domain processing of the plurality of images based on the first gradient level and the second gradient level; and
computing the data pipeline for the computer vision based on the frequency domain processing and the spatial domain processing.

12. The non-transitory computer-readable medium of claim 11, wherein to analyse of dataset the computer-executable instructions are configured for:
employing a learning agent to:
identify a format of the received dataset;
determine the dataset format compatible with an edge device framework;
determine if the received dataset is compatible with the framework by comparing the format of the received dataset and the dataset format compatible with the framework; and
converting, based on the determination that the received dataset is non-compatible with the framework, the format of the received dataset into the dataset format compatible with the framework.

13. The non-transitory computer-readable medium of claim 11, wherein to perform the pre-processing of the dataset the computer-executable instructions are configured for:
categorizing, upon the determining of the second gradient level, the plurality of images based on associated classes using a deep learning model, wherein the categorizing comprising:
assigning a first sub-set of the received dataset as a training dataset;
assigning a second sub-set of the received dataset as a validation dataset for cross validating an output of the deep learning model; and
generating, based on the first sub-set and the second sub-set of the received dataset, annotations and label map of the plurality of images compatible with the deep learning model framework format, wherein generating the annotations and the label map of the plurality of images comprises:
generating the annotation based on a pre-trained object detection model;
generating the label map based on a model inference while executing the model, from associated classes of the plurality of images; and
converting the label map and the annotation to compatible format;
creating, based on the generated annotations and the label map, batches on the subsets of received dataset as training batches and validation batches from the pre-processed dataset;
optimizing the deep learning model based on the training dataset and the validation dataset from the pre-processed dataset; storing the received plurality of images based on the associated classes in different locations; and
converting the format of the plurality of images in each folder into a format compatible with the deep learning model framework.

14. The non-transitory computer-readable medium of claim 11, wherein to preprocess of the received plurality of images the computer-executable instructions are configured for:
determining a mean gradient level associated with the intensity value of each of the plurality of colour channels of pixels, wherein the mean gradient level is computed based on the first gradient level and the second gradient level;
performing the frequency domain processing based on the determined mean gradient level of the plurality for the coloured images, wherein the frequency domain processing comprises analysing the received plurality of images with respect to frequency and time; and
performing, upon performing the frequency domain processing, the spatial domain processing for the coloured images, wherein the spatial domain processing comprising enhancing the received plurality images by manipulating individual pixels based on their spatial coordinates at a specific resolution;
wherein the performing of the frequency domain processing and the spatial domain processing comprises:
determining kernel size and a value of standard deviation associated with a low pass filter, wherein the low pass filter is employed to perform the spatial domain processing;
generating a pre-processed image from the plurality of images of the received dataset, based on the determined kernel size and the value of standard deviation;
implementing the spatial domain processing to highlight a plurality of features of the pre-processed image; and
implementing, upon implementing the spatial domain processing, the frequency domain processing by employing a high pass filter over the pre-processed image.

15. The non-transitory computer-readable medium of claim 11, wherein the data pipeline is computed from either the received plurality of images in the compatible format and deployed in a local environment.
